(19) United States
(12) Patent Application Publication
(10) Pub. No.: US 2004/0254822 A1
(43) Pub. Date: Dec. 16, 2004

(54) System and method for centralized institution admission application submission, processing, analysis, and distribution

(76) Inventor: Steven Jay Mandelbaum, Washington, DC (US)

Correspondence Address: GRAFFITI PROMOTIONS, LLC, 827 WINDSOR ROAD, ARNOLD, MD, 21012, US

(21) Appl. No.: 10/866,568

(22) Filed: Jun. 12, 2004

Related U.S. Application Data
(60) Provisional application No. 60/477,876, filed on Jun. 12, 2003.

(51) Int. Cl. G06F 17/60

(52) U.S. Cl. 705/7

(57) ABSTRACT

Today's institution application process distracts the resources of admissions offices with paper shuffling and processing away from the intellectual match-up of quality applicants and suitable higher education opportunities. The invention replaces this old way of doing things with a more efficient, unified system. This system uses the power of partnership to centrally collect and distribute application information. As a result, the system removes the duplicative administrative efforts, which happen concurrently at each institution, and delivers information and analysis far in excess of what each institution could provide independently.

### CROSS REFERENCE TO RELATED APPLICATIONS

This application claims priority from U.S. Provisional Patent Application Ser. No. 60/477,876, entitled “System and Method for Centralized Institution Admission Application Submission, Processing, Analysis, and Distribution”, filed on Jun. 12, 2003.

### SEQUENCE LISTING OR PROGRAM

Not Applicable

### FEDERALLY SPONSORED RESEARCH

Not Applicable

### TECHNICAL FIELD OF THE INVENTION

This invention relates to the institution application process, and more specifically relates to streamlining the current application process from both the student and institution perspective by eliminating the process of duplication and inefficiency found in the prior art by incorporating a centralized collection system and improved allocation of applicant information.

### BACKGROUND OF THE INVENTION

Each year over 2.3 million high school (649) seniors apply to one or more institutions or universities. Unfortunately, the excitement of applying to institution quickly fades as applicants face the reality of the current application process. The inefficiency of the current system results in the unnecessary stress and labor. Currently applicants (110) are required to, among other things: (A) fill in the same information (154) numerous times for each institution application, (B) spend an inordinate amount of time photocopying and assembling application packages, (C) make numerous calls and inquiries to each institution to which they applied to check on the status of the application, and (D) constantly track down recommendation letters and transcripts to make sure that applications are completed in a timely manner.

Under the current process, when an applicant (110) applies to three different institutions, Institution-1 (116), Institution-2 (117), and Institution-3, (118), she sends the same information (115) directly to each institution to individually process and evaluate for acceptance. Since almost all of the schools receive the same information and process it for the same core results, each institution ends up repeating the same identical work as the others as illustrated in FIG. 1.

The inefficiencies of the current system do not only impact the applicants. Institutions also become frustrated as they face the annual administrative burden of sifting through thousands of applications in search of a top-notch class. The frustration results from the fact that nearly 85% of the administrative process of receiving and evaluating applications is duplicated at each and every institution: from endless data entry and filing to answering numerous inquiries from applicants.

### SUMMARY OF THE INVENTION

Inventor has devised a method and system of applying to institution that simplifies and streamlines the application process by centralizing administrative functions and thereby eliminating duplicative and repetitive efforts performed by both applicants and institutions. From the applicants' perspective, the system features an interview style application questionnaire (610). The answers to this questionnaire are then used to complete the core application (430). Some institutions may also have mini-supplements (450) that may ask additional institution-specific questions.

Further, the system centralizes most administrative functions of the institution application process. It does this by compiling all components of an application package and then distributes it to all the institutions to which an applicant applies. The system is designed to allow applicants to apply to additional institutions with ease, adding the benefit of larger application volumes for institutions.

Although others have invented institution application processes, the present invention is superior. From the viewpoint of an applicant the application process is simplified into a 5 -step process (401), and each applicant's questionnaire (610) is customized and automatically skips irrelevant questions. For example, if the applicant indicates that they have never had a job, the “list jobs” section is skipped. Additionally, the present invention eliminates redundant steps as it is process engineered toward the applicant's completion of each component only once, requires no photocopying or assembling of packages necessary, is customizable to specific institution requirements by enabling institutions that wish to ask additional questions to establish supplements (450), eliminates redundancy as supplements do not request any information already asked.

Applicants are empowered as the present invention enables them to view their real-time status of any application or component on one screen, without making numerous calls or inquiries to each institution, e-mail updates (618) are automatically sent when transcripts and recommendations are received and processed, status reminders (618) are automatically sent every week to notify applicants about incomplete components.

The present invention requires less paperwork for applicants by enabling them to prepare only one form and envelope for their high school (649) and each recommender (618) eliminating the need to worry about the shuffle of a paper trail. Electronic confirmations (618) eliminate the need for post office return receipt records and institution-sent status postcards and help is available 24 hours a day, 7 days a week and service representatives are available online via chat to assist applicants in navigating through the process. Applicants can ask account-specific questions via electronic mail with a guaranteed 24-hour response.

Other additional advantage of the present invention over the prior art are that no additional work is required to apply to additional institutions and a simple fee structure saves money as an applicant pays a low one-time service subscription fee and shares in the efficiency by paying discounted institution application fees.

The advantages from the viewpoint of a institution is a reduction or elimination of paper filings, entire application package is compiled electronically, all forms, transcripts and recommendations are scanned and available for viewing in their original formats, predictable processing and turnaround time, and all documents are opened, scanned and processed within 24 hours, eliminating the administrative lag before applications can be reviewed. Also, applicants know if an item has been misplaced, or “lost in the mail” since it is processed quickly and applicants are immediately notified of its arrival, all data and information are always sorted and displayed in the same predictable format, allowing reviewers to quickly identify key information, better data for analysis and quicker decisions, important grades and standardized tests are displayed in useful and intuitive graphs, which allow for easy trend identification and comparison among peers and the volume of applications allows system to compile a national data-set, providing an ability to benchmark applicants against students in their own high school (649), even if they do not apply to the same partner institutions.

Additional capabilities limited to data from applicants that use the system are: applicants' key metrics are also benchmarked against other applicants to partner institutions who apply through the system; the system can provide ranking of applicants within a high school (649) and institution's applicant pool for the year; best practices and customizable metrics Allow quick analysis; analysis software (607) automatically calculates a customized, institution-specific Academic Index based on standardized tests, subject tests, class rank and/or GPA. Each institution can select specific factors to include and the weight each carries which they know is Verified, Accurate and Credible. Documents received from recommenders and high school (649) officials are promptly acknowledged, confirmed and verified by a follow-up letter to reduce the possibility of fraud. Powerful Workflow Features Electronic “Reading Queues.” Applications can be assigned to a specific evaluator to create “electronic reading queues”.

The system supports progressive changes of status and “grading” to allow partner institutions to send specific applications to “the committee” or any other group, category or person a institution identifies. An end of year analysis comparison reporting is available. Institutions can identify how many of their applicants were accepted or rejected from other specific partners.

Other additional advantages of the present invention over the prior art are that the system uses less storage space since it does not create duplicates of the same information and compiles all components of an application process, not just those which can be filed electronically. It also allows applicants and their advocates (recommenders and school 10 officials) to send their information only once to the system instead of multiple copies to different places. The system of the present invention is also superior to paper-methods or in-house electronic methods employed by an individual institution since it is electronically backed-up and therefore provides information in the event of a hardware crash or some other type of disaster.

The system compiles status of all components in one centralized screen eliminating the need for individual institutions to send status updates or for applicants to request them. It allows a institution to create additional specific supplements that can be directly controlled and customized in the system by the institution thus saving money for applicants by charging discounted application fees. The system allows applicants to apply to additional schools without completing more paperwork while offering user support via 24-hour a day real-time chat. Finally, the system provides comparisons to other applicants to a institution and even to other students from a high school (649), even if they do not apply to the same institution.

### BRIEF DESCRIPTION OF THE DRAWINGS

FIG. 1 illustrates the current process of applying to institution and processing an application;

FIG. 2 illustrates the general concept of the centralized system that streamlines the applicant and institution's process;

FIG. 3 illustrates the an overview of how the centralized system accomplishes the goal;

FIG. 4 illustrates a sample of the system's 5-step applicant process;

FIG. 5 illustrates a sample of the system's applicant file distribution to institutions;

FIG. 6 illustrates a typical applicant review screen as viewed by a partner institution;

FIG. 7 illustrates the user input and review screen as viewed by the applicant.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

Referring to the figures, it is possible to see the various major elements constituting the apparatus of the present invention. The invention is a method and process for a centralized institution admission application submission, processing, analysis, and distribution system for use over a multi-user electronic network such as the Internet, which incorporates a and applicant's view, partner institution view, and a secure server running the centralized system of the present invention. The major system elements consist of database server, multiple subsystems, and multiple users connected over a multi-user electronic network.

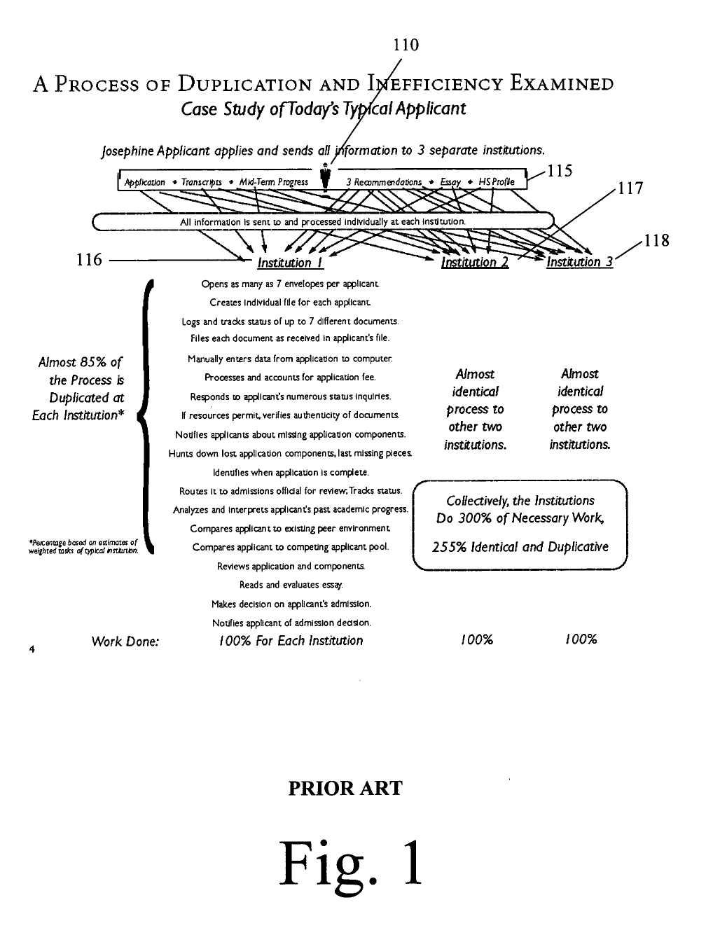

Now referring to FIG. 1, under the current process, when an applicant (110) applies to three different institutions, Institution-1 (116), Institution-2 (117), and Institution-3, (118), she sends the same information (115) directly to each institution to individually process and evaluate for acceptance. Since almost all of the schools receive the same information and process it for the same core results, each institution ends up repeating the same identical work as the others.

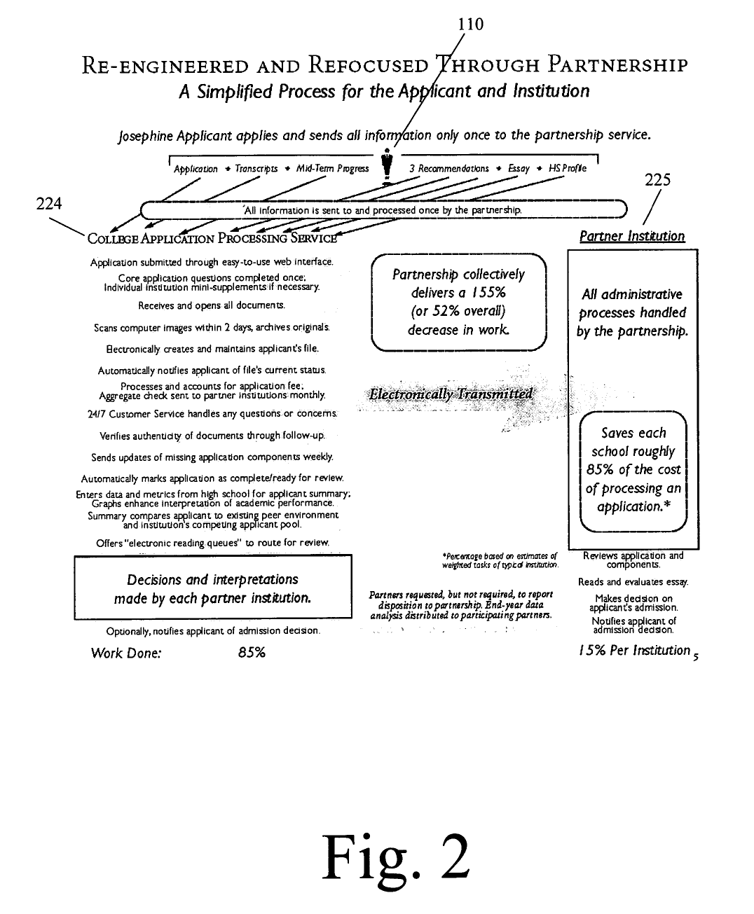

FIG. 2 illustrates a general concept for a centralized system the streamlines the applicant's and institution's admission process. In this scenario, the applicant (110) submits their information only once to a institution application processing service (224) that in turn electronically delivers an entire institution application to a partner institution (265).

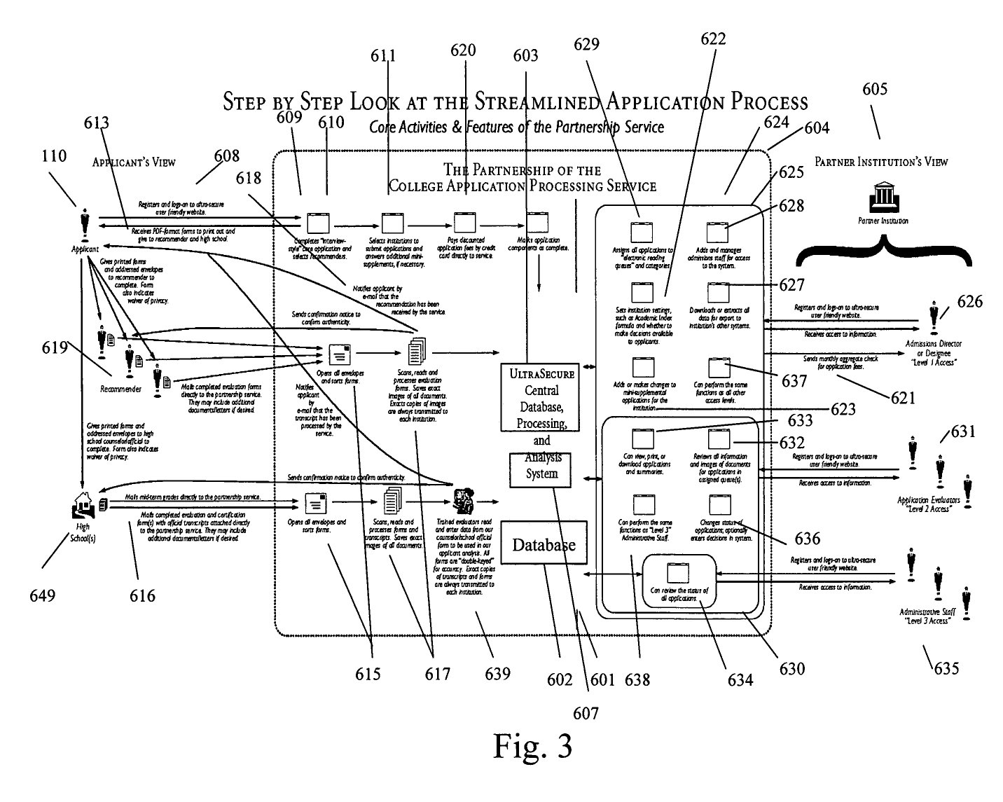

The physical method of operation for the institution application processing service is illustrated in FIG. 3. The centralized admission processing system (604) is a system for collection, communication, storage, analysis, retrieval and delivery of information comprising an ultra-secure central server (601) having random access memory (RAM); a database (602) accessible by applicants, service provider (224), and partner institutions (605) through said central server (601) via internet and/or other web remote access systems; processing software (603) executing on said server (601) for receiving information for applications consisting of biographical information, fee information, institution selections for application, core application questionnaire information, transcripts, reports, recommendations, institution specific supplements, and other data associated with institution applications; said processing software (603) executing on said server (601) for storing received images on said database (602), said processing software (603) on said database (602) for executing on said server (601) for generating an index and electronic applicant file based upon the received information and for storing the selected information; said processing software (603) executing on said server (601) for receiving the information from applicant (610) and partner institution (605) through a communication link; said processing software (603) executing on the central server (601) for storing the information on said central database (602); software executing on server for automatically searching the index in response to a query; and software executing on said server for transmitting the information to the applicant or partner institution (605).

The system as previously described also contains analysis software (607) on server providing data analysis, graphical representation of grade and standardized test scores, compiling of a national data set compilation created from data stored in the database, applicant comparison against selected institution's other applicants found in the central database (602); ranking of applicants within a high school (649) and institution's applicant pool for that year based on data in the central database and continuously calculating national averages or other metrics.

The system as previously described contains said analysis software (607) additionally executing on server (601) partner institution (605) specific academic index base on standard test, subject test, class rank, and or GPA as designed by a partner institution (605) in the central database (602) and said processing software (603) for executing partner institution (605) and applicant (110) updating.

System as defined further compromising said processing software (603) executing on the server (601) with ability for authorizing transmitting of the information, and said processing software (603) with ability for verifying integrity of the authorized information using SSL encryption.

System also contains said analysis software (607) with: a method for periodically monitoring the information stored on the central database (602) to verify the stored data integrity; a method for periodically generating reports on the monitoring results for reference purposes; a method of periodically generating reports on the monitoring results for analysis purposes; a method for storing account and billing information accompanied by the delivery instruction in an account-billing sub-database.

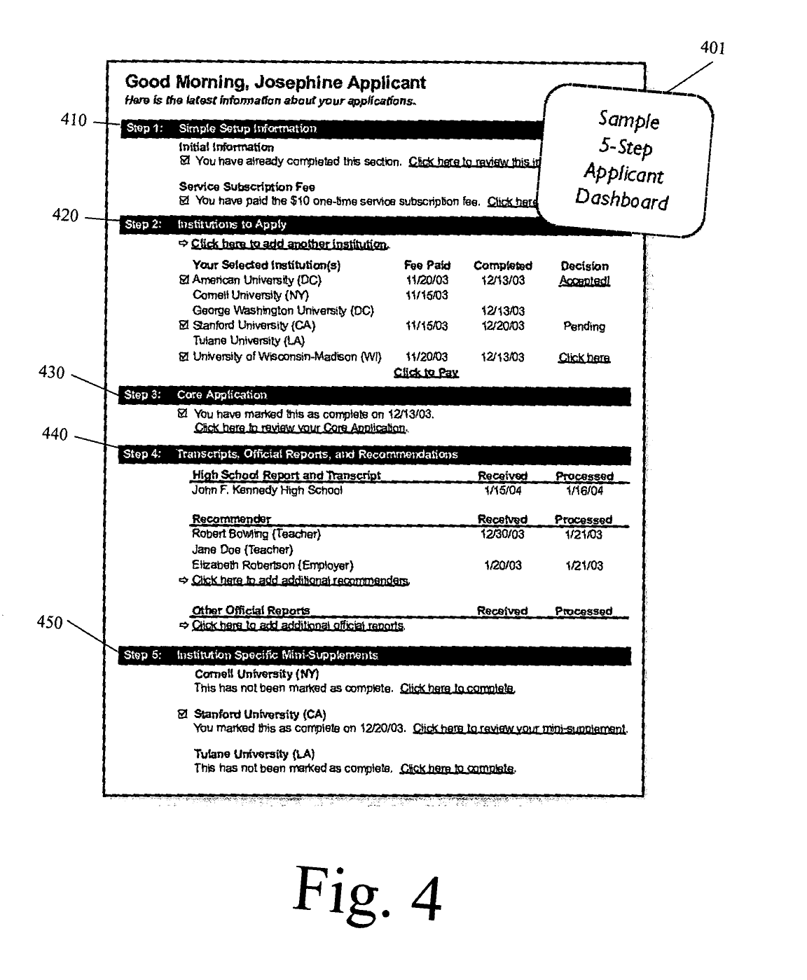

Now referring to FIG. 4, the 5-step applicant process with respect to the method of operation for a centralized admission application submission is shown that may be utilized by institutions, universities or other educational institutions. First, applicants (101) register to use the centralized admission application service provider (224) through a secure Internet web portal (608) by submitting their information through an easy to use 05-step applicant dashboard web interface (609). The 5-step dashboard is a user interface designed as an interview style application where applicants simply answer questions to complete and track their applications.

The First Step (410) is where applicants complete a simple set up section that contains biographical and fee information. The Second Step (420) has applicants selecting the institutions to which they wish to apply (611). The Third Step (430) is completion of the core application that requires the input of information relevant to most standard and/or typical institution applications.

The Fourth Step (440) requires applicants (110) to print out PDF forms (613) which are completed and returned to the centralized admission processing system (604) and supply the applicants' electronic file with images of these PDF forms which are typically High school (649) transcripts, recommendation letters or other official reports. In an alternative embodiment of the present invention a control panel and access to the system is provided to a school officials who can input the request information into the system from a remote location via a multi-user network such as the Internet.

The Fifth Step (450) is the completion of partner institution specific mini-supplements. When all five steps are completed the applicant's electronic profile and application are sent/available to the selected partner institutions (605).

Now referring back to FIG. 3, documentation (615) such as recommendations that are not submitted through the web interface, but which is required, is provided to the applicant in step 613 through portable document format (PDF) forms, which can be downloaded online for completion at a later time. These forms provide a means of submitting information to the applicant's file. They include a privacy waiver, and the address to which they should be returned. Recommendation PDF forms and other supporting documentation or letters are mailed (613) directly to the centralized admission processing system's (604) processing department (639) by the Recommender (619) where they are received through mail delivery and processed (617) by the centralized admission processing system's (604) staff. Other evaluation and certification forms for such things as grade submission are also provided in PDF format so they can be delivered by the Applicant (110) to the evaluator (639), who will then submit them to centralized admission processing system's (604) database (602) directly.

Centralized admission processing system's (604) employees opening the mail envelopes and scanning them into digital form accomplish processing of this printed documentation. In the case of a recommendation, an electronic notice (618) is then generated in the Applicants (110) account to notify them that a document (615) has been received. Other evaluation and certification forms generate a confirmation notice (618) to the provider of the information (619) to confirm authenticity in addition to the Applicant's (110) notification of receipt. In both instances, the images are then electronically attached to the applicants file saving an exact copy of the image, which will later be transmitted to partner institutions as part of the applicants file. Original paperwork is archived for use at a later date or for verification if necessary.

Additionally, the centralized admission processing system (604) verifies the authenticity of documents through follow up measures, and enters data and metrics to create an applicant summary and graph interpretations of academic performance. Trained evaluators (639) read and enter data supplied by school counselors and officials such as evaluations, grades, and other certifications from the official PDF forms into the applicants account for analysis.

Applicant's file is maintained by centralized admission processing system's (604) database 2 electronically and provides the applicant (110), centralized admission processing system's (604) employees, and partner institutions (605) with automatic notifications (618) relevant to their requirements. Applicants are automatically notified of the file's current status, provided weekly updates of the files missing components, and may notify the applicant of an admission decision. Centralized admission processing system (604) receives automatic notification that marks applications as complete/ready for review and electronic reading queues to route for review.

Partner Institutions (605) are provided the applicant's complete file, which includes graphic interpretations of academic performance, comparing applicant to existing peer environment and competing applicant pool and offers. Additionally, the system automatically processes and accounts for application fees (620) that are then submitted to partner institutions (605) in an aggregate monthly payment (621). The centralized admission processing system's (604) effectively processes a student's application once and completes all the administrative work to obtain a complete application that can then be distributed to any number of partner institutions (605) reducing the redundancy of work by current institutions and students.

Partner Institutions also have the ability to create a Institution-Defined Customizable Academic Index (622) and supplemental questionnaires (623) for admission to their respective schools. The partner user interface (624) and access levels allow partner institutions to tailor applicant's submission requirements and to customize their analysis of the data with respect to their own custom academic index (622) and generate reports, graphs, and charts to illustrate the applicant data versus the institution's standards.

The Partner Institution's View is allowed three levels of access to the centralized admission processing system (604) and the applicant information contained therein. The three levels of access are Level 1 (626), Level 2 (630) and Level 3 (635).

Level 1 access (626) is typically granted to Admissions Directors or Designee who can add or change the mini-supplemental applications (623) for the institution, create institution-specific setting such as an Academic Index (622), download data for export to the institution's other system(s) (627), add and manage staff access (628), assign applications to electronic reading queues and categories (629), and perform the same functions (637) as all other access levels (625).

Level 2 access (630) is typically granted to a institution's application evaluators (631) can review all information and images of documents for applications in the assigned queues (632); view, print or download applications and summaries (633); change the status of all applications (636), and perform the same functions as Level 3 access (638).

Level 3 access (635) is typically reserved for administrative staff and restricted to the review of the status of all applications (634).

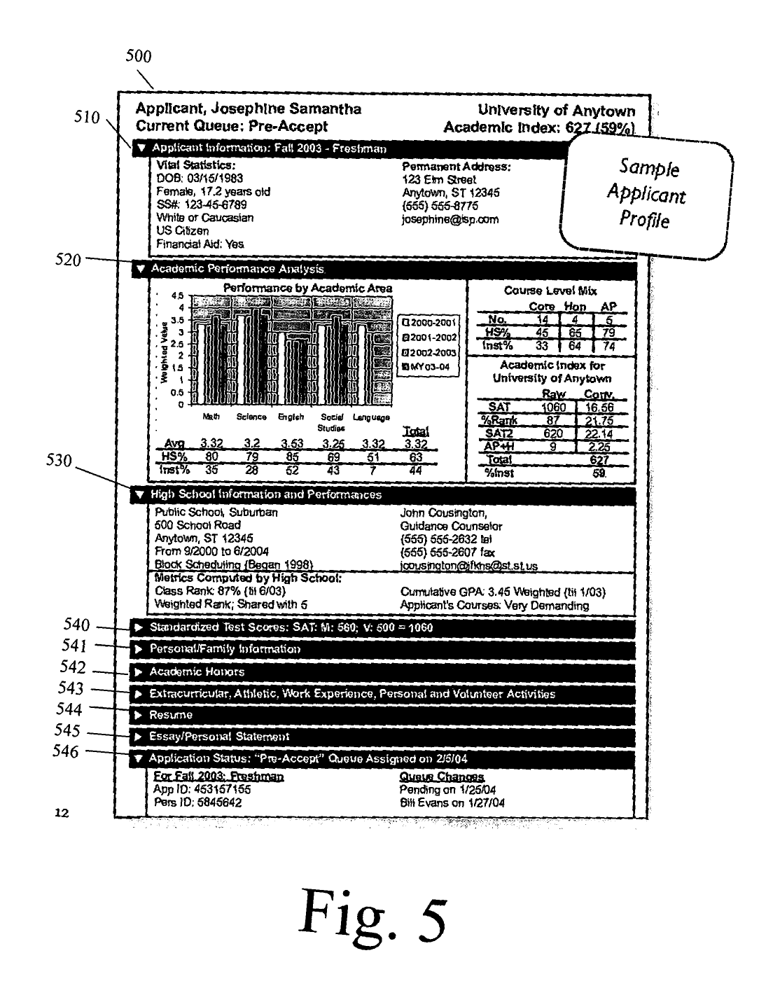

Now referring to FIG. 5, a copy of the applicant's electronic file (460) as delivered to a provider institution (605) is shown. Applicant's file (460) contains the applicant's: information (510), academic performance analysis (520) as set by the partner institution (605), high school (649) information (630), standardized test scores (540), personal family information (541), academic honors (542), extracurricular activities, work exp, etc (543), resume (544), essay (545), and application status (546).

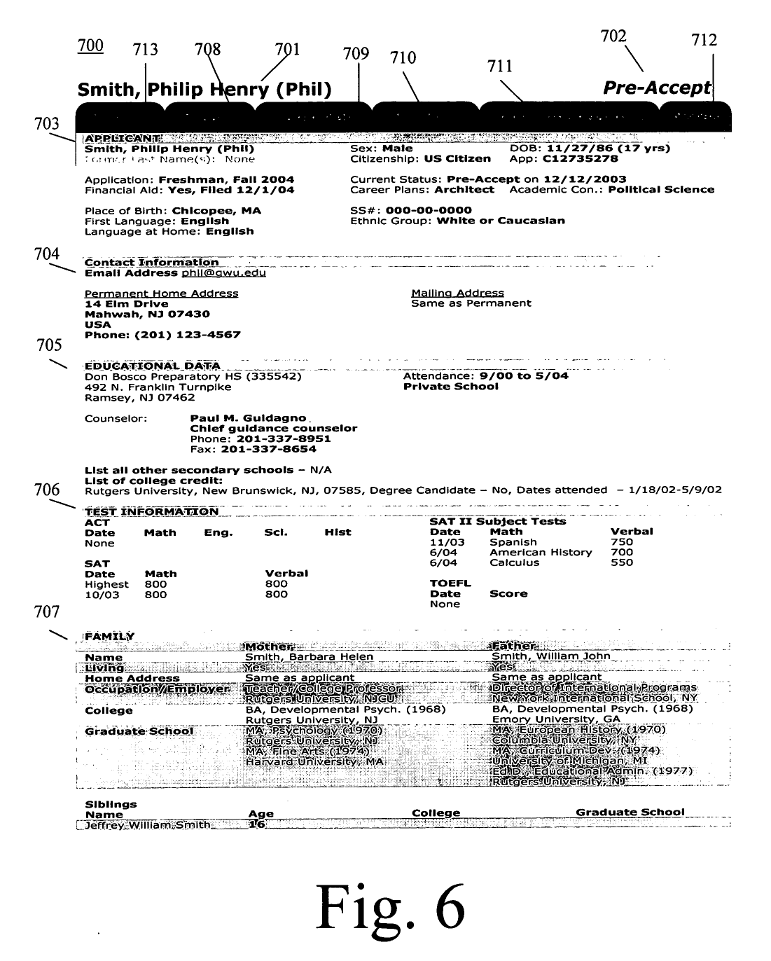

Now referring to FIG. 6 a sample illustration of the review screen (700) as viewed by a partner institution (605). The screen (700) clearly shows the applicants name or other identifier (701) and their status (702) with the partner institution (605) reviewing the file. Any easy to use and well-known tab layout provides easy view of various subclasses in the applicants file. The current screen (700) illustrates what is likely to be found under the applicant's profile (713) and provides the applicant's personal information (703), contact information (704), educational data (705), test information (706), and family information (707). Additionally, the administrator could select any of the plurality of tabs located at the top of the screen (700) to view other important information about the applicant such as their submitted essay (708), transcripts (709), metrics (710), recommendations (711), and other notes (712).

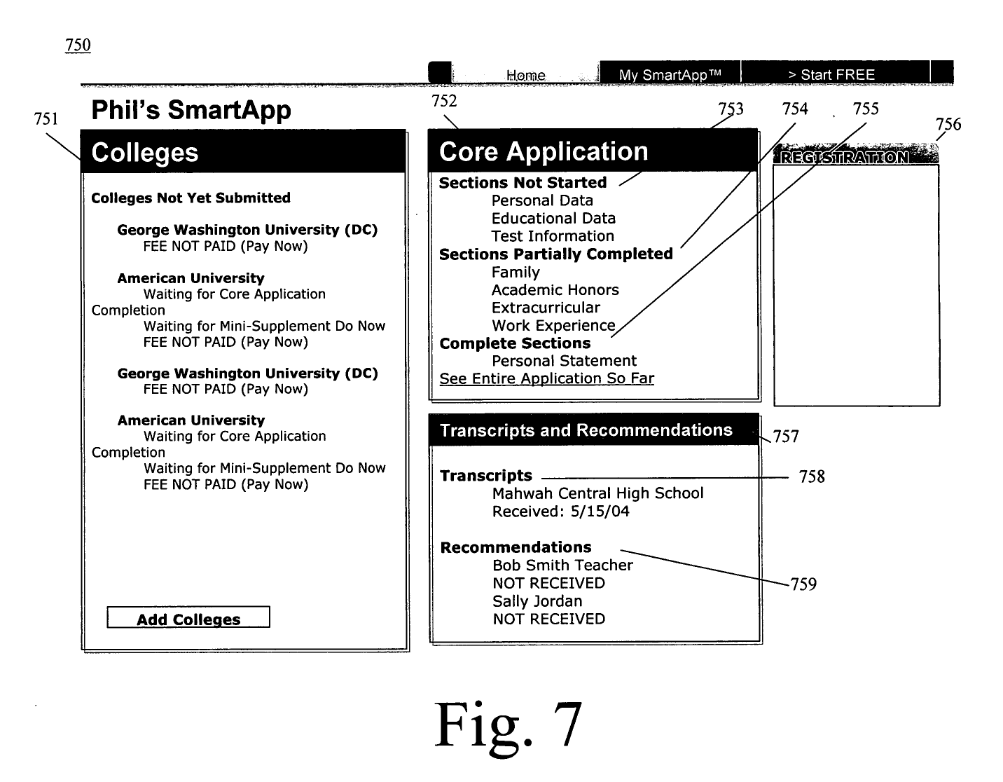

Now referring to FIG. 7 the user input and review screen (750) as viewed by the applicant (110) is illustrated. In the sample review screen one can see how easily the applicant (110) is able to track what institutions (751) to which they intend to apply, the status of the information entered in their core application (752) and transcripts and recommendations (757). The core application (752) is further defined to inform the applicant (110) of which sections have not be started (753), which sections are partially complete (754) and which sections have been completed to date (755). The applicant also has the ability to view their entire application and make changes, corrections, or enter information. The transcripts and recommendations sections (757) enables an applicant (110) to quickly determine whom they have appointed to send recommendations and if there are received (759) as well as track the receipt of transcripts from one or more schools they have attended (758).

In another embodiment of the present invention the system may also exist where all confirmations and submissions occur electronically, either through a web-based interface, electronic mail, XML, FTP or other electronic standard, format or protocol.

In yet another embodiment of the present invention the system may also exist where standardized test scores are sent directly from the testing agency to the centralized admission processing system's (604) service to be compiled in the applicant's electronic file. The may also occur either on paper or electronically.

In still another embodiment of the present invention the system may also exist where the applicant does not interface with the system electronically and completes everything on paper to be sent to and processed by the centralized admission processing system's (604) staff and system. Likewise, it is possible for some parts to be paper-based while others are electronic.

In any embodiment of the present invention the system may also continuously compile an electronic credentials file that an applicant can use or build upon for later use (e.g.: applicant later decides to apply to transfer to another institution and the system still maintains their high school (649) records from the first time they applied).

It is appreciated that the relationships for the parts of the invention, to include variation in database and subsystem configuration to detach them for each other and provide the possibilities to deploy the system in different locations and under different authorities with division of labor, are deemed readily apparent and obvious to one of ordinary skill in the art, and all equivalent relationships to those illustrated in the drawings and described in the above description are intended to be encompassed by the present invention.

In addition, other areas of art may benefit from this method and adjustments to the design are anticipated. Many parts and processes of the system of the present invention may also be used for other application processes. This includes, but is not limited to: Law, Medicine, and Graduate School, Primary and Secondary Schools, Employment, Benefits, Scholarships, and other Credentialing Services. Thus, the scope of the invention should be determined by the appended claims and their legal equivalents, rather than by the examples given.

The embodiments of the invention in which an exclusive property or privilege is claimed are defined as follows:

1. A method of processing application forms over a computer network, the method comprising:
applicant registering for the third party processing service;
presenting to said applicant over a computer network interview style questions for obtaining required information;
said applicant entering requested information for storage in a database;
presenting to said applicant over a computer network necessary forms;
said applicant completing said forms and providing them to the processing system;
said processing system generating submission confirmations;
said applicant entering payment information;
processing by a third party of said information and forms of said applicant to partner institutions;
processing and distribution by a third party of said payment information and payment among said third party and partner institutions.

2. The method of processing application forms over a computer network of claim 1 wherein said forms are recommendation letters and grade transcripts forms which are provided to said applicant by said processing system for distribution to recommenders and schools, said recommenders and schools complete the forms return them to the processing system.

3. The method of processing application forms over a computer network of claim 2 wherein said recommenders and schools may complete forms provided to them by an applicants electronically by directly accessing said processing system over a remote multi-user computer network.

4. The method of processing application forms over a computer network of claim 2 wherein said recommenders and schools mail completed forms to a third party running the processing system where said forms are scanned into a digital format and saved in said database under applicants file.

5. The method of processing application forms over a computer network of claim 4 wherein a trained evaluator enters data from said forms in a double key manner to avoid errors with exact copies of said forms provided to partner institutions upon request.

6. The method of processing application forms over a computer network of claim 1 wherein said applicant's method of registering for the processing service consists of five steps:
step one, said applicant enters simple setup information for their account;
step two, said applicant selects partner institutions in which they desire to submit applicants;
step three, said applicant completes all information for the core application;
step four, said applicant provides or has submitted additional documentation such as transcripts, official reports, and recommendations;
step five, said applicant completes any partner institution specific supplements as required.

7. The method of processing application forms over a computer network of claim 6 wherein depending on said applicant's selection of institutions in step two, the five-step method of registering for the processing service;
only presents steps to said applicant for completion as required by the selected institutions; and
only requests information from said applicant that is required by the selected institutions.

8. The method of processing application forms over a computer network of claim 1 wherein said partner institutions are allowed one or more levels of access to the processing system and the applicant information contained therein.

9. The method of processing application forms over a computer network of claim 8 wherein
the three levels of access are Level 1, Level 2 and Level 3:
Level 3 access is typically reserved for administrative staff and restricted to the review of the status of all applications;
Level 2 access is granted to a partner institution's application evaluators who can review all information and images of documents for applications; view, print or download applications and summaries; change the status of all applications, and perform the same functions as Level 3 access;
Level 1 access is granted to Admissions Directors or a Designee who can add or change the mini-supplemental applications for the institution, create institution-specific setting such as an Academic Index, download data for export to the institution's other system, add and manage staff access, assign applications to electronic reading queues and categories, and perform the same functions as all other access levels.

10. The method of processing application forms over a computer network of claims 1, 8 and 9 wherein,
all applicant information is sorted and displayed in the same predictable format,
allowing reviewers to quickly identify key information and access to better data for analysis and quicker decision-making;
grades and standardized tests are displayed in useful and intuitive graphs, which allow for easy trend identification and comparison among peers; and
the processing system compiles a national data-set, providing an ability to benchmark applicants against students in their own high school, even if they do not apply to the same partner institutions.

11. The method of processing application forms over a computer network of claim 10 wherein additional capabilities limited to data from applicants that use the system are:
applicants' key metrics are also benchmarked against other applicants to partner institutions who apply through the system;
rankings of applicants within a high school (649) and institution's applicant pool for the year are created;
best practices and customizable metrics allow quick analysis;
analysis software automatically calculates a customized, institution-specific academic index based on standardized tests, subject tests, class rank and/or grade point average;
partner institutions can select specific factors to include and the weight each carries which they know is verified, accurate and credible.

12. The method of processing application forms over a computer network of claim 11 wherein electronic reading queues can be create from a group of applicant files and then assigned to a specific evaluators.

13. The method of processing application forms over a computer network of claim 11 wherein an end of year analysis comparison report is available so that partner institutions can identify how many of their applicants were accepted or rejected from other specific partner institutions.
